(19) United States
(12) Patent Application Publication
(10) Pub. No.: US 2013/0256499 A1
(43) Pub. Date: Oct. 3, 2013

(54) MOUNTING DEVICE FOR FAN

(71) Applicant: ZHENG-HENG SUN, Tu-Cheng (TW)

(72) Inventor: ZHENG-HENG SUN, Tu-Cheng (TW)

(73) Assignee: HON HAI PRECISION INDUSTRY CO., LTD., Tu-Cheng (TW)

(21) Appl. No.: 13/445,940

(22) Filed: Apr. 13, 2012

(30) Foreign Application Priority Data
Mar. 28, 2012 (CN) 201210085950.X

(51) Int. Cl. F16M 13/00

(52) U.S. Cl. 248/674

(57) ABSTRACT

A mounting device for fixing a fan having two opposite boards includes a bottom wall and a number of fixing members mounted to outer surfaces of the boards. Each fixing member defines a through hole. The bottom wall forms a number of rods capable of extending through the through holes of the corresponding fixing members.

### CROSS-REFERENCE TO RELATED APPLICATIONS

Relevant subject matter is disclosed in two pending U.S. patent applications, both titled “MOUNTING DEVICE FOR FAN”, respectively filed on Apr. 2, 2012, with the application Ser. No. 13/437,025 and filed on Apr. 12, 2012, with the application Ser. No. 13/444,875, which are assigned to the same assignee as this patent application.

### BACKGROUND

1. Technical Field

The present disclosure relates to a device for mounting fans.

2. Description of Related Art

Many electronic devices use fans to cool internal electronic components. The fans may be mounted to a rack by a plurality of screws, and then is mounted in an electronic device together with the rack, which adds cost of the rack.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of a first embodiment of a mounting device, together with a plurality of fans.

FIG. 2 is an assembled, isometric view of the mounting device and the fans of FIG. 1.

FIG. 3 is an exploded, isometric view of a second embodiment of a mounting device, together with a plurality of fans.

FIG. 4 is an assembled, isometric view of the mounting device and the fans of FIG. 3.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

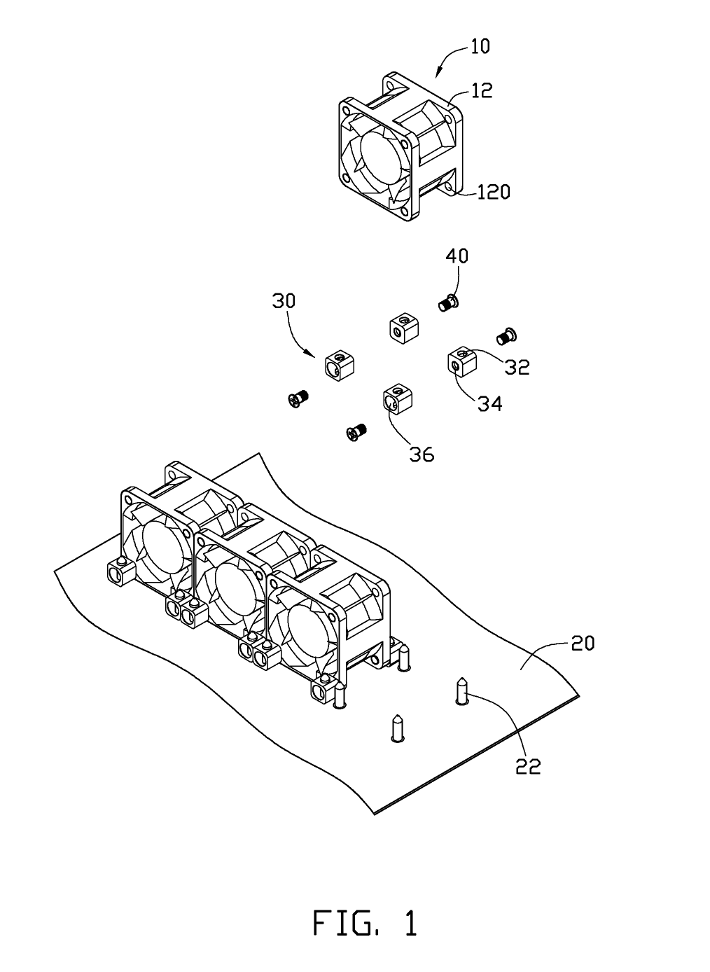

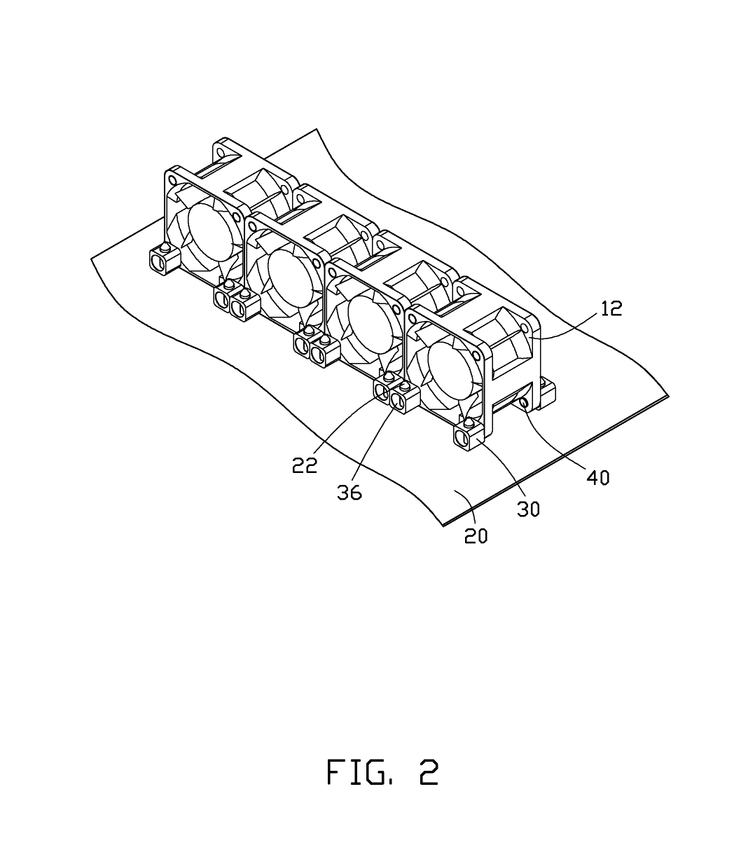

Referring to FIGS. 1 and 2, a first exemplary embodiment of a mounting device for fixing a plurality of fans 10 includes a base board 20 and a plurality of fixing members.

Each fan 10 includes two spaced boards 12. Each board 12 defines two corner holes 120 in a lower portion. In the first embodiment, the corner holes 120 are threaded holes.

The base board 20 forms a plurality of rods 22. Each rod 22 has a tapered distal end.

Each fixing member includes a screw 40 and a block 30.

The block 30 is hollow and substantially cube-shaped. The block 30 defines a fixing hole 32 extending through a top surface and a bottom surface of the block 30, a threaded hole 34 extending through a first side of the block 30, and an opening 36 extending through a second side of the block 30 opposite to the first side and communicating with the threaded hole 34. The diameter of the opening 36 is greater than the diameter of the threaded hole 34.

In mounting each fan 10 to the base board 20, the threaded holes 34 of four blocks 30 are respectively aligned with the corner holes 120 of the fan 10 from outer surfaces of the corresponding boards 12. Four screws 40 extended through the corresponding openings 36 and the corresponding threaded holes 34, to be engaged in the corresponding corner holes 120, thereby fixing the blocks 30 to outer surfaces of the boards 12. The fixing holes 32 firmly fit about four corresponding rods 22, to fix the fan 10 to the base board 20.

The screws 40 may extend through the corner holes 120 of the fan 10 from a space between the boards 12 and then are engaged into the threaded holes 34, to fix the blocks 30 to outer surfaces of the boards 12.

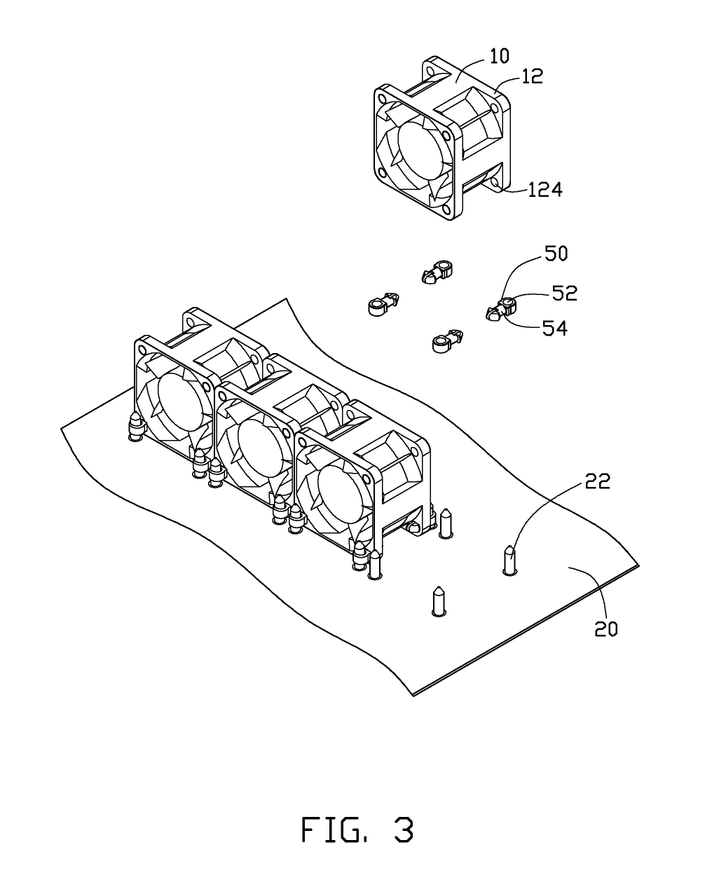

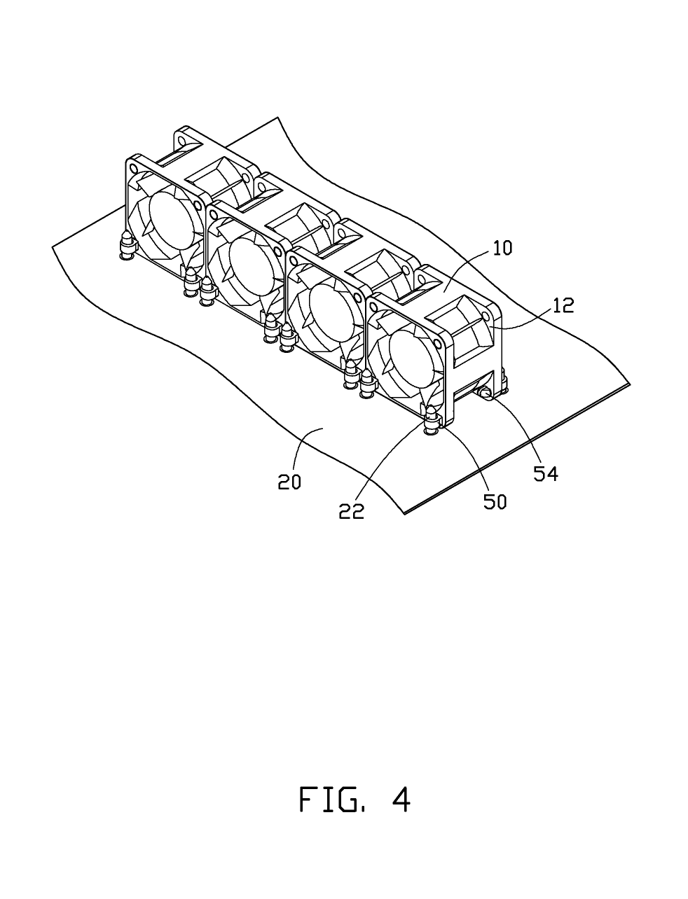

Referring to FIGS. 3 and 4, in a second embodiment, each fixing member includes a block 50 and two spaced latches 54 extending out from a side of the block 50. In the second embodiment, the corner holes 124 of the fan 10 are through holes. Each latch 54 has a wedge-shaped distal end. The block 50 defines a fixing hole 52 extending through a top surface and a bottom surface of the block 50. The latches 54 of each fixing member are deformed toward each other to extend through one of the corner holes 124 and then are engaged with an inner surface of the corresponding board 12, to fix the block 50 to an outer surface of the corresponding board 12. The fixing holes 52 firmly fit about the corresponding rods 22

It is believed that the present embodiments and their advantages will be understood from the foregoing description, and various changes may be made thereto without departing from the spirit and scope of the description or sacrificing all of their material advantages, the examples hereinbefore described merely being exemplary embodiments.

What is claimed is:

1. A mounting device for mounting a fan having two opposite boards, comprising:
a base board forming a plurality of rods; and
a plurality of fixing members to be mounted to the boards, each fixing member defining a fixing hole extending through a top and a bottom of the fixing member;
wherein the rods extend through the fixing holes for fixing the fan on the base.

2. The mounting device of claim 1, wherein each fixing member comprises a block defining a fixing hole extending through a top and a bottom of the block, and a fastener to fix the block to a corresponding one of the boards of the fan.

3. The mounting device of claim 2, wherein the block defines a threaded hole in a side, the fastener is extended through the corresponding board and then is engaged in the threaded hole, to fix the block to an outer surface of the board.

4. The mounting device of claim 2, wherein the block defines a threaded hole and an opening in opposite sides, the threaded hole and the opening communicate with each other, the fastener extends through the opening and the threaded hole to be engaged in the corresponding board, to fix the block to an outer surface of the board.

5. The mounting device of claim 1, wherein each fixing member comprises a block defining a fixing hole extending through a top and a bottom of the block, and two spaced latches extending out from a side of the block, the latches are operable to be deformed toward each other to extend through the corresponding board and then be engaged with an inner surface of the board, to fix the block to an outer surface of the board.
